(19) United States
(12) Patent Application Publication
(10) Pub. No.: US 2024/0267897 A1
(43) Pub. Date: Aug. 8, 2024

(54) SYSTEMS AND METHODS OF MLD LEVEL PARAMETERS

(71) Applicant: Meta Platforms Technologies, LLC, Menlo Park, CA (US)

(72) Inventors: Muhammad Kumail Haider, Sunnyvale, CA (US); Binita Gupta, San Diego, CA (US); Chunyu Hu, Saratoga, CA (US)

(73) Assignee: Meta Platforms Technologies, LLC, Menlo Park, CA (US)

(21) Appl. No.: 18/400,124

(22) Filed: Dec. 29, 2023

Related U.S. Application Data
(60) Provisional application No. 63/443,191, filed on Feb. 3, 2023.

(51) Int. Cl. H04W 72/0446; H04W 84/12; H04W 88/10

(52) U.S. Cl. CPC H04W 72/0446; H04W 84/12; H04W 88/10

(57) ABSTRACT

A device within an access point multi-link device (AP MLD) having a plurality of wireless links, may include one or more processors configured to generate a frame including a first subfield, the first subfield indicating whether there is an update on one or more basic service set (BSS) level parameters or one or more MLD level parameters different from the one or more BSS level parameters. The one or more processors may determine whether there is an update on the one or more MLD level parameters. Responsive to determining that there is an update on the one or more MLD level parameters, the one or more processors may set the first subfield to a first value. The one or more processors may wirelessly transmit, through a transmitter via a link of the plurality of wireless links corresponding to the device in a wireless local area network (WLAN), the frame.

### CROSS-REFERENCE TO RELATED APPLICATION

This application claims priority to U.S. Provisional Patent Application No. 63/443,191 filed on Feb. 3, 2023, which is incorporated by reference herein in its entirety for all purposes.

### FIELD OF DISCLOSURE

The present disclosure is generally related to communications, including but not limited systems and methods of signaling critical updates for Multi-Link Device (MLD) level parameters for an AP MLD to an associated non-AP MLD.

### BACKGROUND

Artificial reality such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

Various embodiments disclosed herein are related to a device within an access point multi-link device (AP MLD) having a plurality of wireless links, the device including one or more processors. In some embodiments, the one or more processors may be configured to generate a first frame including a first subfield. The first subfield may indicate whether there is an update on one or more basic service set (BSS) level parameters or one or more MLD level parameters different from the one or more BSS level parameters. The one or more processors may be configured to determine whether there is an update on the one or more MLD level parameters. Responsive to determining that there is an update on the one or more MLD level parameters, the one or more processors may be configured to set the first subfield to a first value. The one or more processors may be configured to wirelessly transmit, through a transmitter via a link of the plurality of wireless links corresponding to the device in a wireless local area network (WLAN), the first frame.

In some embodiments, the first frame may include a second subfield indicating a number of changes of the one or more BSS parameters. The one or more processors may be configured to determine whether there is a change to a value carried in the second subfield. Responsive to determining that there is a change to a value carried in the second subfield, the one or more processors may be configured to set the first subfield to the first value. In some embodiments, the first frame may be one of a beacon or a probe response frame.

In some embodiments, the one or more MLD level parameters may be carried in at least one of a basic multi-link element, a reconfiguration multi-link element, a traffic identifier (TID)-to-link mapping element, or a multi-link traffic indication element. In some embodiments, the update on the one or more MLD level parameters may relate to at least one of (1) adding a new device to the AP MLD, (2) removing a device from the AP MLD, (3) updating a value of a medium synchronization delay information subfield, (4) updating a value of an enhanced multi-link (EML) capabilities subfield, or (5) updating a value of an MLD capabilities and operations subfield.

In some embodiments, in setting the first subfield to the first value, the one or more processors may be configured to set the first subfield to the first value until and including an end of a predetermined time interval. The predetermined time interval may be a delivery traffic indication message (DTIM) interval on the link.

Various embodiments disclosed herein are related to a device within a non-access point multi-link device (non-AP MLD) having a plurality of wireless links, the device including one or more processors. In some embodiments, the one or more processors may be configured to receive, through a receiver via a link of the plurality of wireless links corresponding to the device in a wireless local area network (WLAN), a first frame from an AP MLD. The first frame may include a first subfield, the first subfield indicating whether there is an update on one or more basic service set (BSS) level parameters or one or more MLD level parameters different from the one or more BSS level parameters. The one or more processors may be configured to determine whether the first subfield is set to a first value indicating that there is an update on the one or more BSS level parameters or the one or more MLD level parameters. Responsive to determining that the first subfield is set to the first value, the one or more processors may be configured to determine one or more updated MLD level parameters. The one or more processors may be configured to perform reconfiguration of the device using the one or more updated MLD level parameters.

In some embodiments, the first frame may include a second subfield indicating a number of changes of the one or more BSS parameters. Responsive to determining that the first subfield is set to the first value, the one or more processors may be configured to determine, based at least on a value of the second subfield, one or more updated BSS level parameters. The one or more processors may be configured to perform reconfiguration of the device using the one or more updated BSS level parameters. In some embodiments, the first frame may be one of a beacon or a probe response frame.

In some embodiments, the one or more MLD level parameters may be carried in at least one of a basic multi-link element, a reconfiguration multi-link element, a traffic identifier (TID)-to-link mapping element, or a multi-link traffic indication element. In some embodiments, the update on the one or more MLD level parameters may relate to at least one of (1) adding a new device to the AP MLD, (2) removing a device from the AP MLD, (3) updating a value of a medium synchronization delay information subfield, (4) updating a value of an enhanced multi-link (EML) capabilities subfield, or (5) updating a value of an MLD capabilities and operations subfield.

In some embodiments, responsive to determining that the device has not received a beacon frame from the AP MLD, the one or more processors may be configured to wirelessly transmit, through a transmitter via the link to the AP MLD, a second frame requesting the one or more MLD level parameters. The first frame may be received responsive to transmitting the second frame.

Various embodiments disclosed herein are related to a method including generating, by a device within an access point multi-link device (AP MLD) having a plurality of wireless links, a first frame including a first subfield. The first subfield may indicate whether there is an update on one or more basic service set (BSS) level parameters or one or more MLD level parameters different from the one or more BSS level parameters. The method may include determining, by the device, whether there is an update on the one or more MLD level parameters. The method may include responsive to determining that there is an update on the one or more MLD level parameters, setting, by the device, the first subfield to a first value. The method may include wirelessly transmitting, by the device through a transmitter via a link of the plurality of wireless links corresponding to the device in a wireless local area network (WLAN), the first frame.

In some embodiments, the first frame may include a second subfield indicating a number of changes of the one or more BSS parameters. The device may determine whether there is a change to a value carried in the second subfield. Responsive to determining that there is a change to a value carried in the second subfield, the device may set the first subfield to the first value. In some embodiments, the first frame may be one of a beacon or a probe response frame.

In some embodiments, the one or more MLD level parameters may be carried in at least one of a basic multi-link element, a reconfiguration multi-link element, a traffic identifier (TID)-to-link mapping element, or a multi-link traffic indication element. In some embodiments, the update on the one or more MLD level parameters may relate to at least one of (1) adding a new device to the AP MLD, (2) removing a device from the AP MLD, (3) updating a value of a medium synchronization delay information subfield, (4) updating a value of an enhanced multi-link (EML) capabilities subfield, or (5) updating a value of an MLD capabilities and operations subfield.

In some embodiments, in setting the first subfield to the first value, the device may set the first subfield to the first value until and including an end of a predetermined time interval. The predetermined time interval may be a delivery traffic indication message (DTIM) interval on the link.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a block diagram of an example configuration of an access point multi-link device (AP MLD) and a non-AP MLD according to an example implementation of the present disclosure.

FIG. 5A to FIG. 5E illustrate example(s) of field formats for signaling updates on BSS parameters, according to an example implementation of the present disclosure.

FIG. 6A to FIG. 6C illustrate example(s) of field formats for signaling updates on BSS parameters, according to an example implementation of the present disclosure.

FIG. 7A to FIG. 7C illustrate example(s) of field formats relating to MLD parameters, according to an example implementation of the present disclosure.

FIG. 8 illustrate an example field format relating to reconfiguration multi-link element, according to an example implementation of the present disclosure.

FIG. 9A to FIG. 9B illustrate example(s) of field formats for signaling updates on MLD parameters, according to an example implementation of the present disclosure.

FIG. 10 illustrates another example field format for signaling updates on MLD parameters, according to an example implementation of the present disclosure.

FIG. 11A to FIG. 11C illustrate example(s) of field formats for signaling updates on MLD parameters, according to an example implementation of the present disclosure.

FIG. 12 is a flowchart showing a process of signaling updates on MLD parameters, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

### 1. Example Configuration of Artificial Reality Systems

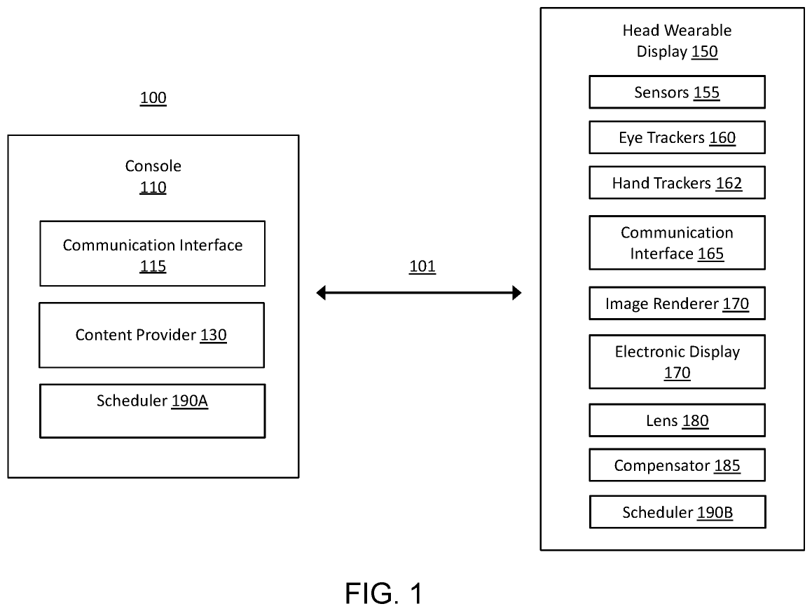

FIG. 1 is a block diagram of an example artificial reality system environment 100 in which a console 110 operates. FIG. 1 provides an example environment in which devices may communicate traffic streams with different latency sensitivities/requirements. In some embodiments, the artificial reality system environment 100 includes a HWD 150 worn by a user, and a console 110 providing content of artificial reality to the HWD 150. A head wearable display (HWD) may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the console 110 through a wired or wireless connection. The HWD 150 may also identify objects (e.g., body, hand face).

The console 110 may determine a view within the space of the artificial reality corresponding to the detected location, orientation and/or the gaze direction, and generate an image depicting the determined view. The console 110 may also receive one or more user inputs and modify the image according to the user inputs. The console 110 may provide the image to the HWD 150 for rendering. The image of the space of the artificial reality corresponding to the user's view can be presented to the user. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150, and/or some of the functionality of the HWD 150 may be performed by the console 110.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, eye trackers 160, a communication interface 165, an image renderer 170, an electronic display 175, a lens 180, and a compensator 185. These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and/or an orientation of the hand. The hand tracker 162 may generate hand tracking measurements indicating the detected shape, location and/or orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the console 110 and the head wearable display 150 are implemented on a single system, the communication interface 165 may communicate with the console 110 through a bus connection or a conductive trace. Through the communication link, the communication interface 165 may transmit to the console 110 sensor measurements indicating the determined location of the HWD 150, orientation of the HWD 150, the determined gaze direction of the user, and/or hand tracking measurements. Moreover, through the communication link, the communication interface 165 may receive from the console 110 sensor measurements indicating or corresponding to an image to be rendered.

Using the communication interface, the console 110 (or HWD 150) may coordinate operations on link 101 to reduce collisions or interferences. For example, the console 110 may coordinate communication between the console 110 and the HWD 150. In some implementations, the console 110 may transmit a beacon frame periodically to announce/advertise a presence of a wireless link between the console 110 and the HWD 150 (or between two HWDs). In an implementation, the HWD 150 may monitor for or receive the beacon frame from the console 110, and can schedule communication with the HWD 150 (e.g., using the information in the beacon frame, such as an offset value) to avoid collision or interference with communication between the console 110 and/or HWD 150 and other devices.

The console 110 and HWD 150 may communicate using link 101 (e.g., intralink). Data (e.g., a traffic stream) may flow in a direction on link 101. For example, the console 110 may communicate using a downlink (DL) communication to the HWD 150 and the HWD 150 may communicate using an uplink (UL) communication to the console 110.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, data describing an image to be rendered, and render the image through the electronic display 175. In some embodiments, the data from the console 110 may be encoded, and the image renderer 170 may decode the data to generate and render the image. In one aspect, the image renderer 170 receives the encoded image from the console 110, and decodes the encoded image, such that a communication bandwidth between the console 110 and the HWD 150 can be reduced.

In some embodiments, the image renderer 170 receives, from the console, 110 additional data including object information indicating virtual objects in the artificial reality space and depth information indicating depth (or distances from the HWD 150) of the virtual objects. Accordingly, the image renderer 170 may receive from the console 110 object information and/or depth information. The image renderer 170 may also receive updated sensor measurements from the sensors 155. The process of detecting, by the HWD 150, the location and the orientation of the HWD 150 and/or the gaze direction of the user wearing the HWD 150, and generating and transmitting, by the console 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer 170 may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality.

In other implementations, the image renderer 170 generates one or more images through a shading process and a reprojection process when an image from the console 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view. In other embodiments, the console 110 includes more, fewer, or different components than shown in FIG. 1. In some embodiments, the console 110 is integrated as part of the HWD 150. In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., USB cable, a wireless link). Through the communication link, the communication interface 115 may receive from the HWD 150 sensor measurements indicating the determined location and/or orientation of the HWD 150, the determined gaze direction of the user, and/or hand tracking measurements. Moreover, through the communication link, the communication interface 115 may transmit to the HWD 150 data describing an image to be rendered.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space.

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

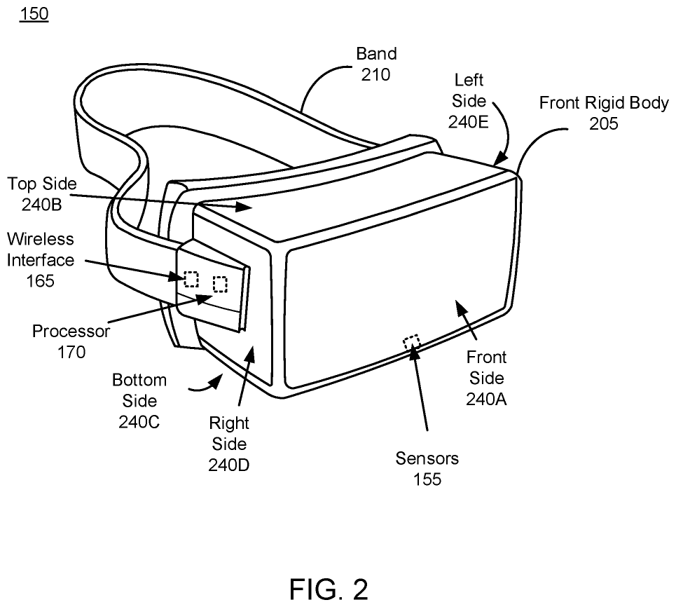

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the sensors 155 are located within the front rigid body 205, and may not visible to the user. In other embodiments, the HWD 150 has a different configuration than shown in FIG. 2. For example, the image renderer 170, the eye trackers 160A, 160B, and/or the sensors 155 may be in different locations than shown in FIG. 2.

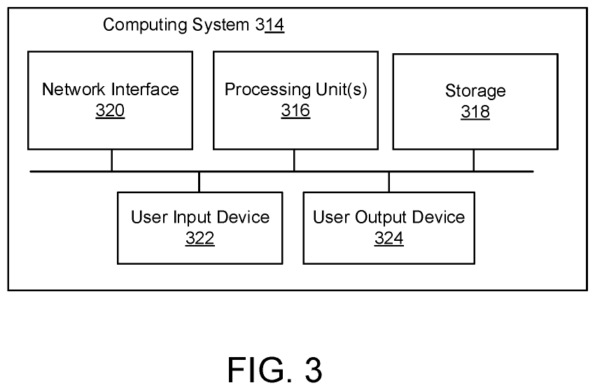

Various operations described herein can be implemented on computer systems. FIG. 3 shows a block diagram of a representative computing system 314 usable to implement the present disclosure. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained.

Implementations of the present disclosure can be realized in a variety of apparatus including electronic devices implemented using any combination of circuitry and software.

### 2. Example Configuration of Artificial Reality Systems

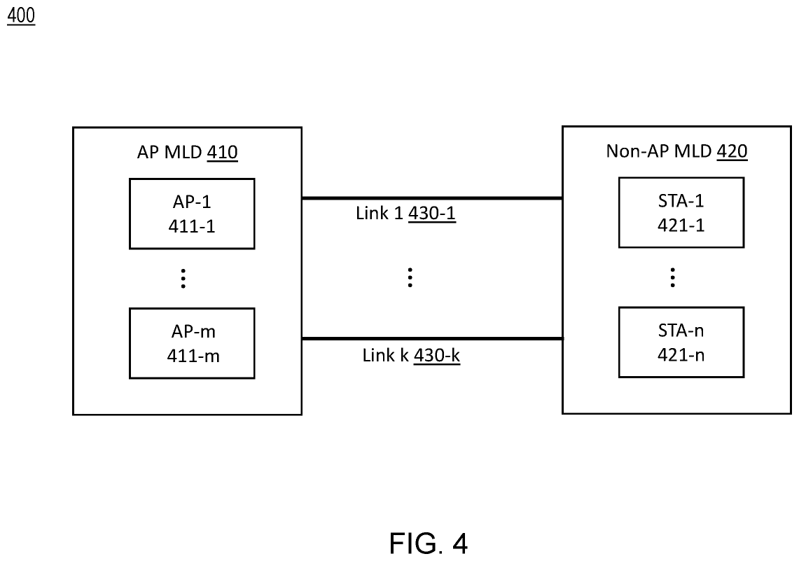

FIG. 4 is a block diagram of an example configuration 400 of an access point multi-link device (AP MLD) 410, a non-AP MLD 420, and a plurality of links (e.g., k links or channels 430-1, . . . , 430-k where k is an integer greater than 1) according to an example implementation of the present disclosure. The AP MLD 410 may include a first AP device (or first AP) 411-1 (e.g., first AP radio transceiver; “AP-1” in FIG. 4), . . . , and an m^{th} AP device (or m^{th} AP) 411-m (e.g., m^{th} AP radio transceiver; “AP-m” in FIG. 4), where m is an integer greater than 1. Each of the first-to-m^{th} devices may have a 1×1 radio or 2×2 radio. Similarly, the non-AP MLD 420 may include a first STA device (or first STA) 421-1 (e.g., first STA radio transceiver; “STA-1” in FIG. 4), . . . , and an n^{th} STA device (or n^{th} STA) 421-n (e.g., n^{th} STA radio transceiver; “STA-n” in FIG. 4), where n is an integer greater than 1. Each of the first-to-n^{th} STA devices may be a 1×1 radio or 2×2 radio. Each AP device of the AP MLD 410 may be associated with one or two links of the plurality of links to transmit or receive one or more frames to/from a corresponding STA device of the non-AP MLD 420. Similarly, each STA device of the non-AP MLD 420 may be associated with one or two links of the plurality of links to transmit or receive one or more frames to/from a corresponding AP device of the AP MLD 410.

### 3. Critical Updates Procedure for Basic Service Set (BSS) Level Parameters

A BSS parameter critical update procedure may define how an AP MLD (e.g., AP MLD 410) indicates per BSS level parameters critical updates. Each AP (e.g., each AP device of the AP MLD 410) may include, in Beacon frames and/or Probe Response frames, a BSS Parameter Change Count (BPCC) subfield for each of the APs affiliated with the same AP MLD as the AP itself. Each AP may have its own BPCC value which is initialized to 0 for an AP and may be incremented by 1 (using, for example, module 256 operation, excluding value 255) when one of predetermined critical update events happens. The following events about the BSS parameters of an AP are example critical update events that the AP may classify as a critical update:
Inclusion of a Channel Switch Announcement element;
Inclusion of an Extended Channel Switch Announcement element;
Modification of the Enhanced Distributed Channel Access (EDCA) parameters element;
Inclusion of a Quiet element;
Modification of the direct-sequence spread spectrum (DSSS) Parameter Set;
Modification of the High Throughput (HT) Operation element;
Inclusion of a Wide Bandwidth Channel Switch element;
Inclusion of a Channel Switch Wrapper element;
Inclusion of an Operating Mode Notification element;
Inclusion of a Quiet Channel element;
Modification of the Very High Throughput (VHT) Operation element;
Modification of the High Efficiency (HE) Operation element;
Insertion of a Broadcast Target wake time (TWT) element;
Insertion of a Broadcast TWT Parameter Set field in an existing Broadcast TWT element;
Inclusion of the BSS Color Change Announcement element;
Modification of the Multi-User (MU) EDCA Parameter Set element;
Modification of the Spatial Reuse Parameter Set element;
Modification of the OFDMA-based random access (UORA) Parameter Set element;
Modification of the Extremely High Throughput (EHT) Operation element

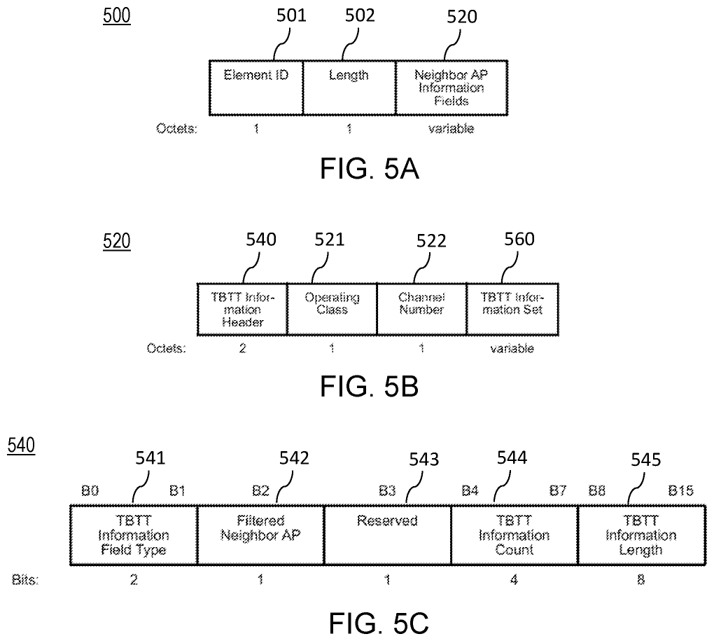

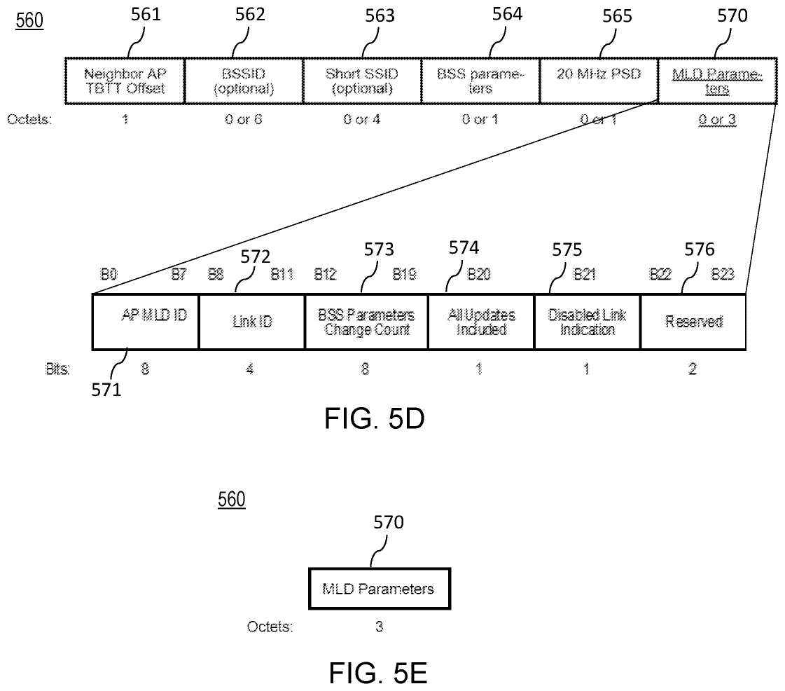

FIG. 5A to FIG. 5E illustrate one example of field formats for signaling updates on BSS parameters, according to an example implementation of the present disclosure. FIG. 5A shows a Reduced Neighbor Report element format 500 including the fields of Element ID 501, Length 502, and/or Neighbor AP Information Fields 520. FIG. 5B shows the Neighbor AP Information field format 520 including the subfields of Target Beacon Transmission Time (TBTT) Information Header 540, Operating Class 521, Channel Number 522, and/or TBTT Information Set (or TBTT Information subfield) 560. FIG. 5C shows the TBTT Information Header subfield format 540 including the subfields of TBTT Information Field Type 541, Filtered Neighbor AP 542, Reserved 543, TBTT Information Count 544, and/or TBTT Information Length 545. FIG. 5D shows the TBTT Information field format 560 including the subfields of Neighbor AP TBTT Offset 561, BSSID 562, Short SSID 563, BSS parameters 564, 20 MHz PSD 565, and/or MLD Parameters 570. The MLD Parameters subfield 670 may include the subfields of AP MLD ID 571, Link ID 572, BSS Parameters Change Count (also referred to as “BPCC”) 573, All Updates Included 574, Disabled Link Indication 575, and/or Reserved 576. FIG. 5E shows the TBTT Information field format 560 may only contain 3 octets of the MLD Parameters subfield, when the TBTT Information Field Type sub-field 541 is equal to 1 and the TBTT Information Length subfield 545 is equal to 3. The TBTT Information field 560 can contain MLD Parameters subfield 570 including the BPCC subfield 573 either along with other parameters as captured in FIG. 5D or just by itself as captured in FIG. 5E.

An AP may classify other changes (other than those listed above) in the Beacon frame as critical updates. In Beacon and Probe Response frames, the BPCC subfield for each of the other AP(s) affiliated with the AP MLD may be carried in the MLD Parameters subfield (e.g., MLD Parameter subfield 570 in FIG. 5D) in the TBTT Information field (e.g., TBTT Information field 560 in FIG. 5D) of the Reduced Neighbor Report element (e.g., Reduced Neighbor Report element 500 in FIG. 5A) corresponding to that AP where each of the other AP(s) may be identified by the Link ID subfield (e.g., Link ID field 572 in FIG. 5D) of the MLD Parameters subfield.

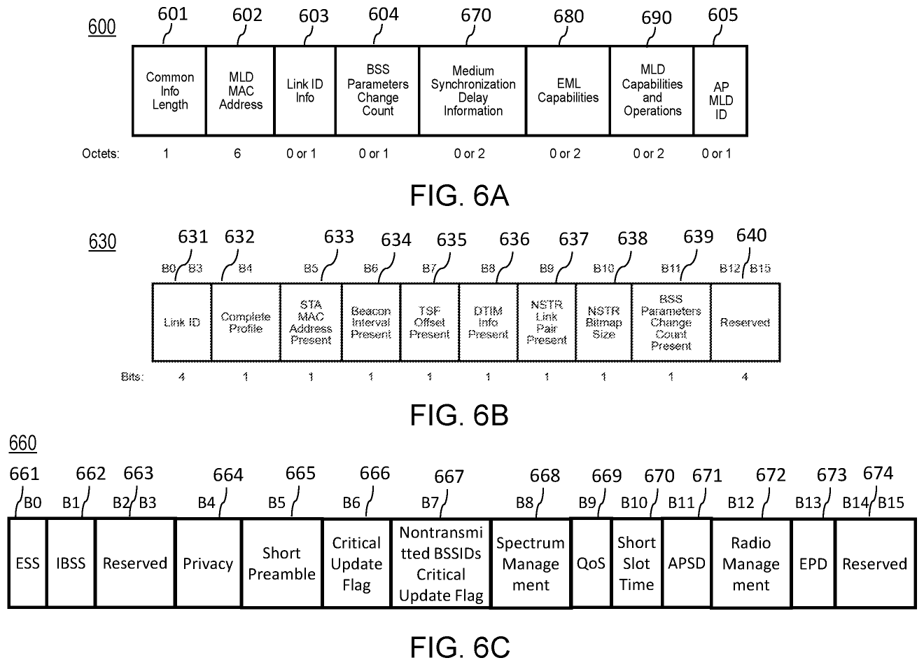

FIG. 6A to FIG. 6C illustrate example(s) of field formats for signaling updates on BSS parameters, according to example implementation(s) of the present disclosure. FIG. 6A shows a format of Common Info field 600 of a Basic Multi-Link element format. The Common Info field 600 may include the subfields of Common Info Length 601, MLD MAC Address 602, Link ID Info 603, BSS Parameters Change Count (also referred to as “BPCC”) 604, Medium Synchronization Delay Information 670, EML Capabilities 680, MLD Capabilities and Operations 690, and/or AP MLD ID 605. FIG. 6B shows a STA Control field format 630 of a Per-STA Profile sub-element (not shown) for the Basic Multi-Link element format. The STA Control field format 630 may include the subfields of Link ID 631, Complete Profile 632, STA MAC Address Present 633, Beacon Interval Present 634, TSF Offset Present 636, NSTR Link Pair Present 637, NSTR Bitmap Size 638, BSS Parameters Change Count Present (also referred to as “BPCC present”) 639, and/or Reserved 640. FIG. 6C shows a Capability Information field format 660 (for non-Directional Multi-Gigabit (DMB) STA) including the subfields of ESS 661, IBSS 662, Reserved 663, Privacy 664, Short Preamble 665, Critical Update Flag (also referred to as “CUF”) 666, Non-transmitted BSSIDs Critical Update Flag 667, Spectrum Management 668, QoS 669, Short Slot Time 670, APSD 671, Radio Management 672, EPD 673, and/or Reserved 674.

As shown in FIG. 6A, the BPCC subfield 604 for the AP may be carried in the Common Info field 600 of the Basic Multi-Link element where the AP is identified by the Link ID subfield 603 of the Common Info field 600. In a (Re)Association Response frame, a BPCC subfield for each of the other AP(s) affiliated with the AP MLD may be carried in a STA Info subfield in the Per-STA Profile sub-element (not shown) of the Basic Multi-Link element corresponding to that AP where each of the other AP(s) may be identified by the Link ID subfield 631 of the STA Control field 630 of the Per-STA Profile sub-element In addition, as shown in FIG. 6C, the AP may set the Critical Update Flag subfield 666 of the Capability Information field 660 to 1 in Beacon and Probe Response frames until and including the next DTIM Beacon frame on the link on which the AP is operating if there is a change to a value carried in the BPCC subfield 573 of the MLD Parameters field 570 in the Reduced Neighbor Report element 500 for any AP affiliated with the same AP MLD as the AP or a value carried in the BPCC subfield 604 in the Common Info field 600 of the Basic Multi-Link element.

For each reported AP affiliated with the same AP MLD as the AP, the All Updates Included subfield 574 may be set to 1 in the MLD Parameters subfield 570 in the TBTT Information field 560 of the Reduced Neighbor Report element 500 corresponding to the reported AP if the updated elements that correspond to the latest critical update that has generated a change to the value carried in the BPCC subfield 573 for the reported AP are included in the frame carrying the Reduced Neighbor Report element 500.

The purpose of incrementing the BPCC parameter (e.g., the BPCC subfield 573) for a BSS/AP may be to indicate to STAs (e.g., STAs of a non-AP MLD 420) that one or more critical updates have happened to the corresponding BSS so that the STAs may acquire latest parameters from the Beacon or Probe Response for that BSS. Behavior for non-AP STAs related to the BPCC parameter will be described as follows.

A non-AP MLD (e.g., non-AP MLD 420) may maintain a record of the most recently received BPCC subfield value for each associated AP in the AP MLD (e.g., AP MLD 410). When a non-AP STA affiliated with a non-AP MLD receives a BPCC subfield for a certain AP that is affiliated with an AP MLD with which the non-AP MLD has performed multi-link setup and the value of the BPCC subfield for the AP is different from the previously received value, then the non-AP MLD may follow one of the following mechanisms: (1) the non-AP STA affiliated with the non-AP MLD that is associated with the AP may attempt to receive a Beacon frame or a Probe Response frame from the AP; or (2) any non-AP STA affiliated with the non-AP MLD may attempt to send a Probe Request frame to its associated AP soliciting information of the AP. Except that if (1) the value in the BPCC subfield (e.g., BPCC subfield 573) is equal to the most recently received value recorded by the non-AP MLD for that AP plus 1 and (2) the All Updates Included subfield (e.g., All Updates Included subfield 574) in the MLD Parameters subfield (e.g., MLD Parameters subfield 570) in the TBTT Information field (e.g., TBTT Information field 560) of the Reduced Neighbor Report element (e.g., Reduced Neighbor Report element 500) corresponding to the AP is set to 1, no further action may be performed from the non-AP MLD as the updated elements are included in the received frame.

### 4. Signaling Updates on MLD Level Parameters

The Multi-Link Operation (MLO) feature may enable a non-AP MLD (e.g., non-AP MLD 420) with one or more affiliated non-AP STAs (e.g., STA-1 421-1, . . . , STA-n 421-n) to establish association over multiple links with an AP MLD (e.g., AP MLD 410) with one or more affiliated APs (e.g., AP-1 411-1, . . . , AP-m 411-m). The Multi-Link (ML) operation may define a number of MLD level parameters which may be carried in the Basic Multi-Link element in Beacon and Probe Response frames. The MLD level parameters may be also carried in other multi-link specific elements. It would be beneficial to define a mechanism to notify non-AP MLDs when critical MLD level parameters are updated by the AP MLD. The critical MLD level parameters may include MLD level parameters in one or more of elements in Beacon or Probe Response carrying MLD level parameters. Such elements may include (1) Basic Multi-Link element, (2) Reconfiguration Multi-Link element, (3) TID (Traffic Identifier)-to-Link Mapping element, and/or (4) Multi-Link Traffic Indication element. The Basic Multi-Link element may include following MLD level parameters in the Common Info field (e.g., Common Info field 600 in FIG. 6A): Medium Synchronization Delay Information 670, Enhanced Multi-Link (EML) Capabilities 680, MLD Capabilities and Operations 690.

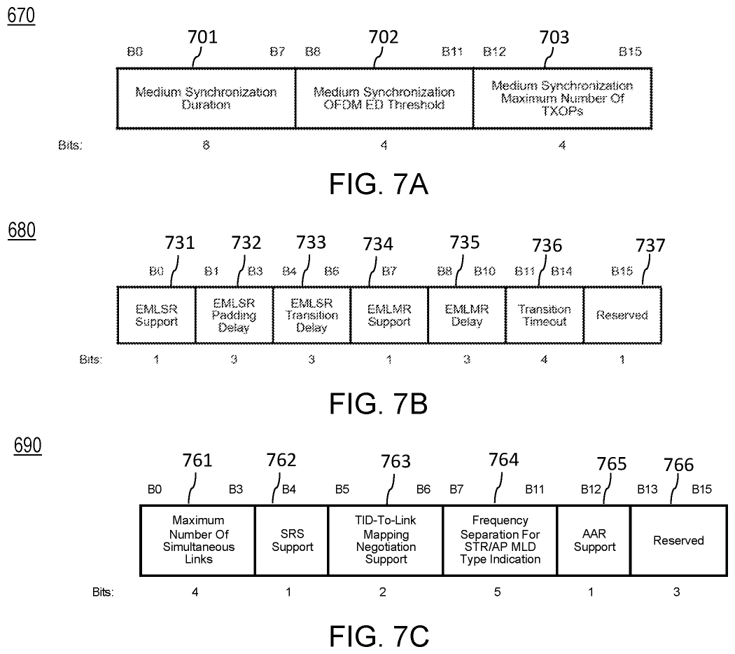

FIG. 7A to FIG. 7C illustrate example(s) of field formats relating to MLD parameters, according to example implementation(s) of the present disclosure. FIG. 7A shows the Medium Synchronization Delay Information subfield format 670 including the subfields of Medium Synchronization Duration 701, Medium Synchronization OFDM ED Threshold 702, Medium Synchronization Maximum Number of TXOPs 703. FIG. 7B shows the Medium Synchronization Delay Information subfield format 680 including the subfields of Enhanced Multi-Link Single-Radio (also referred to as “EMLSR”) Support 731, EMLSR Padding Delay 732, EMLSR Transition Delay 733, Enhanced Multi-Link Multi-Radio (also referred to as “EMLMR”) Support 734, EMLMR Delay 735, Transition Timeout 736, and/or Reserved 737. FIG. 7C shows the MLD Capabilities and Operations subfield format 690 including the subfields of Maximum Number of Simultaneous Links 761, SRS Support 762, Traffic Identifier (TID)-To-Link Mapping Negotiation Support 763, Frequency Separation For STR/AP MLD Type Indication 764, AAR Support 765, and/or Reserved 766. As shown in FIG. 7C, the MLD Capabilities and Operations subfield format 690 may include MLD level parameters such as Maximum Number of Simultaneous Links 761, TID-To-Link Mapping Negotiation Support 763, and/or other MLD level parameters.

The MLD level parameters in the Basic ML element may be advertised by the AP in Beacon and Probe Response frames and can be updated to indicate change(s) in any of the AP MLD capabilities indicated in the Basic ML element (e.g., MLD Capabilities and Operations subfield format 690). It would be beneficial to notify non-AP MLDs about the updates to MLD level parameters. It is beneficial to indicate to non-AP MLDs which are associated with an AP MLD that critical MLD level parameters have been updated, so that an associated non-AP MLD can consider updated AP MLD capabilities in its ML operation with the AP MLD.

For example, if the Maximum Number of Simultaneous Links (e.g., Maximum Number of Simultaneous Links subfield 761) is increased, it may indicate that a new AP has been added at the AP MLD. Knowing/detecting/being aware of this information, the non-AP MLD can perform ML association which includes the new link as well and can achieve better overall performance. If TID-To-Link Mapping Negotiation Support (e.g., TID-To-Link Mapping Negotiation Support subfield 763) is updated from value 1 to value 3, the non-AP MLD can respond to this change and establish more flexible TID-to-Link mapping over associated links which can prioritize low-latency traffic on certain higher quality link (e.g. 6 GHZ). If EML Capabilities (e.g., EML Capabilities subfield 680) are updated by the AP MLD (for example, EMLSR Support (subfield 731) or EMLMR Support (subfield 734) are enabled), then the non-AP MLD can take this information into account and perform EMLSR or EMLMR operations with the AP MLD.

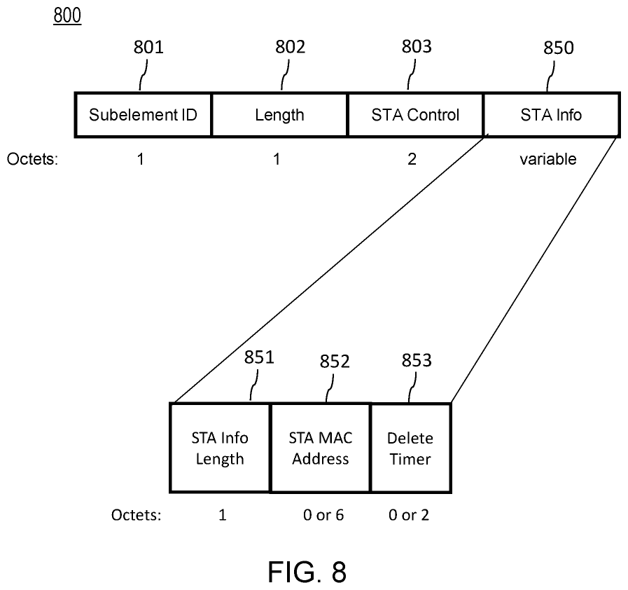

FIG. 8 illustrates example field format(s) relating to reconfiguration multi-link element, according to an example implementation of the present disclosure. FIG. 8 shows a Per-STA Profile sub-element 800 for a Reconfiguration Multi-Link element. The Per-STA Profile sub-element 800 may include the fields of Sub-element ID 801, Length 802, STA Control 803, and/or STA Info 850. The STA Info field format 850 may include the subfields of STA Info Length 851, STA MAC Address 852, and/or Delete Timer 853.

The Reconfiguration Multi-Link element may be sent in Beacon and Probe Response frames and can provide information about one or more affiliated APs being removed from the AP MLD. The Reconfiguration Multi-Link element may indicate to the non-AP MLDs when a specific affiliated AP is to be removed by providing a Delete Timer value (e.g., Delete Timer subfield 853) for the AP removal in the STA Info field (e.g., STA Info field 850). It is beneficial for the non-AP MLD to receive this information, so that the non-AP MLD can learn/determine which AP/APs are being removed and can adjust/control its ML operation accordingly to avoid any disruption to its operation.

The TID-to-Link Mapping element advertised in the Beacon may provide information on which APs/links are being disabled or later enabled by the AP MLD. It is also beneficial for a non-AP MLD to receive this information immediately, so that the non-AP MLD can learn/determine which APs are being disabled and can adjust/control its ML operation accordingly to avoid any disruption to its operation.

A Critical Update Flag (CUF) subfield (e.g., CUF subfield 666) of the Capability Information field (e.g., Capability Information field 660) may be set to 1 in Beacon and Probe Response frames until and including the next Delivery Traffic Indication Message (DTIM) Beacon frame on the link on which the AP is operating, for the updates related to at least the following elements: (1) Reconfiguration Multi-Link element, and/or (2) TID-to-Link Mapping element.

However, this mechanism (using the CUF subfield) may not be sufficient to notify non-AP MLDs. When the non-AP MLDs can miss (due to interference, sleep, or other reasons) Beacons where the CUF subfield was set, since the CUF is only set until next DTIM Beacon (which is for 2 Beacons in most typical deployments), the non-AP MLDs may not be able to be notified of the CUF. If a non-AP MLD misses the Beacons with CUF set then the non-AP MLD cannot determine that the MLD level parameters have been updated for the elements indicated above (e.g., Reconfiguration Multi-Link element, and/or TID-to-Link Mapping element) and may miss those updates. In addition, the CUF may not be set for updates to MLD parameters in the Basic ML element, hence those updates (e.g., MLD Parameters subfield 570 in the Basic ML element) cannot be indicated to the non-AP MLD according to the conventional CUF mechanism.

Moreover, the CUF subfield can be set to 1 for BSS level parameter updates as well, so when the CUF subfield is set for BSS level parameters update, the non-AP MLD may interpret CUF for BSS level parameters update and may miss receiving updated MLD level parameters. Hence, it is beneficial to define a mechanism to notify non-AP MLDs when critical MLD level parameters are updated by the AP MLD. The critical MLD level parameters may include MLD level parameters in one or more of the following elements or other elements in Beacon or Probe Response carrying MLD level parameters: (1) Basic Multi-Link element, (2) Reconfiguration Multi-Link element, (3) TID-to-Link Mapping element, and/or (4) Multi-Link Traffic Indication element.

To solve these problems, embodiments of the present disclosure provide mechanisms to indicate MLD level parameters critical updates. In a first embodiment, a method/system may indicate MLD level parameters critical updates by incrementing the existing BPCC subfield for all affiliated APs. In a second embodiment, a method/system may add a new MLD Parameters Change Count (MPCC) subfield to indicate critical updates to MLD level parameters. In a third embodiment, a method/system may use the existing CUF subfield to also indicate critical updates to MLD level parameters. In a fourth embodiment, a method/system may define a new MLD Parameters Critical Update Flag (MP-CUF) subfield and can set the MP-CUF subfield to indicate critical updates to MLD level parameters. In a fifth embodiment, a method/system may add both a new MLD Parameters Critical Update Flag (MP-CUF) subfield and a new MLD Parameters Change Count (MPCC) subfield. The method/system may use both subfields together to indicate critical MLD level parameters update to non-AP MLDs.

### 5. First Example Embodiment

In the first embodiment, a method/system may indicate MLD level parameters critical updates by incrementing the existing BSS Parameters Change Count (BPCC) subfield. The BPCC may be incremented (by module 256 operation, excluding value 255) to indicate critical updates to MLD level parameters carried by elements in Beacon or Probe Response frames.

Updates to MLD level parameters in one or more elements can be classified as critical updates for MLD level parameters. The following elements are examples of such elements: (1) Basic Multi-Link element, (2) Reconfiguration Multi-Link element, (3) TID-to-Link Mapping element, and/or (4) Multi-Link Traffic Indication element. Updates to MLD level parameters in other elements not listed above may also be considered as critical updates for MLD level parameters by the AP MLD and may result in incrementing of BPCC.

### 5-1. AP MLD Behavior

Following behaviors/procedures/processes are defined to indicate MLD level parameters critical updates to non-AP MLDs. First, the existing BSS Parameters Change Count (BPCC) subfield which is defined to indicate BSS level parameters update may be extended to also indicate critical updates to MLD level parameters. Whenever any critical updates on MLD level parameters happen for the AP MLD, a system/method may increment the BPCC for each of the APs affiliated with the AP MLD. The updated BPCC value may be carried/included/indicated in the Common Info field for the reporting AP and in the reduced neighbor report (RNR) element's TBTT Information field for other APs. Second, since the updated MLD parameters are carried in the Beacon frames for each affiliated AP, the existing All Updates Included subfield may be set to 1 in the TBTT Information field of the RNR element for each AP. The All Updates Included subfield may indicate to non-AP MLDs that all the relevant updates are included in the current management frame and an AP does not need to acquire Beacon frames from other APs of the same AP MLD. Third, the AP MLD may set the existing Critical Update Flag (CUF) subfield to 1 until and including the next DTIM Beacon frame, to trigger a non-AP MLD to examine the latest BPCC value.

### 5-2. Non-AP MLD Behavior

The non-AP MLD may perform following behaviors/procedures/processes to detect and acquire latest MLD level parameters critical updates. First, the non-AP MLD may maintain/store a record of the most recently received BSS Parameters Change Count subfield value for each associated AP of the AP MLD. Second, when the non-AP MLD identifies that the CUF is set, the non-AP MLD may examine a BPCC value from the latest received RNR element for neighbor APs and the Basic ML element for the current AP (the reporting AP) to determine if that BPCC value is different than the stored BPCC value for those APs. Third, when the non-AP MLD determines that the BPCC value (from the latest received RNR element) is different than the stored BPCC values for all of the associated APs, the non-AP MLD may re-acquire latest MLD level parameters critical updates from the current management frame (e.g., Beacon frame or Probe Response frame) by acquiring Multi-Link specific elements which are defined as carrying critical MLD level parameters including one or more elements listed above plus any other elements carrying MLD level parameters.

This first embodiment may ensure that the non-AP MLD does not miss any critical MLD level parameters update, even if the non-AP MLD misses the Beacons where CUF was set. This is because the non-AP MLD may identify that the BPCC value is incremented and then may acquire the latest critical updates for the MLD level parameters from the Beacon or Probe Response frame. One drawback of the first embodiment is that a system/method can trigger acquisition of critical MLD level parameters even when only BSS level parameters are updated for each of the affiliated APs, since the BPCC subfield may get incremented even in that case and the non-AP MLD may interpret that as critical updates to MLD level parameters. This may result in less efficient operation for the non-AP MLD in such scenarios (e.g., when only BSS level parameters are updated for each of the affiliated APs).

### 6. Second Embodiment

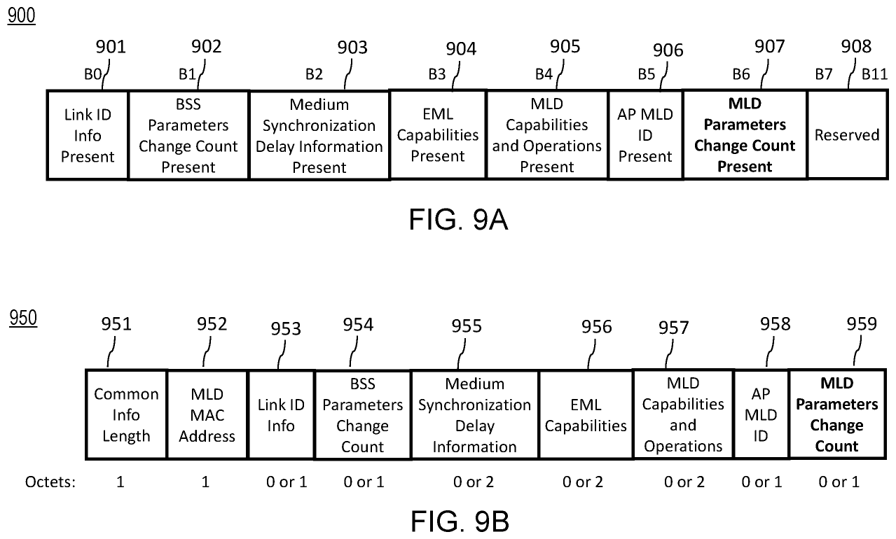

FIG. 9A to FIG. 9B illustrate example(s) of field formats for signaling updates on MLD parameters, according to example implementation(s) of the present disclosure. FIG. 9A shows a Presence Bitmap subfield 900 of the Basic Multi-Link element format according to an example implementation of the present disclosure. The Presence Bitmap subfield 900 may include the subfields of Link ID Info Present 901, BSS Parameters Change Count (BPCC) Present 902, Medium Synchronization Delay Information Present 903, EML Capabilities Present 904, MLD Capabilities and Operations Present 905, AP MLD ID present 905, MLD Parameters Change Count Present (also referred to as “MPCC Present”) 907, and/or Reserved 908. FIG. 9B shows a Common Info field format 950 of the Basic Multi-Link element format according to an example implementation of the present disclosure. The Common Info field format 950 may include the subfields of Common Info Length 951, MLD MAC Address 952, Link ID Info 953, BSS Parameters Change Count (BPCC) 954, Medium Synchronization Delay Information 955, EML Capabilities 956, MLD Capabilities and Operations 957, AP MLD ID 958, and/or MLD Parameters Change Count (also referred to as “MPCC”) 959.

In the second embodiments, a system/method may add a new MLD Parameters Change Count (MPCC) subfield (e.g., MPCC subfield 959) to indicate critical updates to MLD level parameters. The new MPCC subfield may be carried in the Common Info field (e.g., Common Info field format 950) of the Basic Multi-Link element in the Beacon and Probe Response frames and the (Re)Association Response frame. The AP MLD may increment the MPCC subfield (by module 256 operation, excluding value 255) whenever any of the critical MLD level parameters are updated.

Updates to MLD level parameters in one or more of following elements can be classified as critical updates for MLD level parameters: (1) Basic Multi-Link element (excluding update to MPCC itself), (2) Reconfiguration Multi-Link element, (3) TID-to-Link Mapping element, and/or (4) Multi-Link Traffic Indication element. Updates to MLD level parameters in other elements not listed above may also be considered as critical updates for MLD level parameters by the AP MLD and may result in incrementing of MPCC value. A single MPCC value may be maintained by the AP MLD and may be carried in the Common Infor field of the Basic ML element (e.g., MPCC subfield 959). Since the MPCC subfield itself is carried in the Basic ML element, an update to MPCC may not result in updating MPCC again.

The Basic Multi-Link element may be updated to include the MPCC subfield as follows. The “MLD Parameters Change Count Present” or “MPCC Present” subfield may be added in the Presence Bitmap subfield of the Basic ML element (e.g., Presence Bitmap subfield 900) to indicate the presence of the MLD Parameters Change Count subfield. The “MLD Parameters Change Count Present” subfield may be set to 1 if the MPCC subfield (e.g., MPCC subfield 959) is included in the Common Info field (e.g., Common Info field 950) for the Basic ML element. Otherwise, this “MLD Parameters Change Count Present” subfield may be set to 0.

### 6-1. AP MLD Behavior

An AP MLD may perform the following behaviors/procedures/processes to indicate MLD level parameters critical updates to non-AP MLDs with MPCC. First, whenever any critical updates on MLD level parameters happen for the AP MLD, the AP MLD may increment the MPCC for the AP MLD. The updated MPCC value may be carried in the Common Info field of the Basic ML element by the reporting AP. Each affiliated AP of the AP MLD may include MPCC subfield in the Basic ML element in the Beacon and Probe Response frames the AP transmits. The MPCC value may also be carried in the Basic ML element in the (Re)Association Response frame. Second, the AP MLD may set the Critical Update Flag (CUF) subfield to 1 until and including the next DTIM Beacon frame, to trigger a non-AP MLD to examine the latest MPCC value.

### 6-2. Non-AP MLD Behavior

The non-AP MLD may perform the following behaviors/procedures/processes to detect and/or acquire latest MLD level parameters critical updates. First, the non-AP MLD may maintain/store a record of the most recently received MPCC subfield value for the AP MLD it is associated with. Second, when the non-AP MLD identifies that CUF is set (to 1), the non-AP MLD may examine an MPCC value from the latest received Basic ML element to determine if that value is different than the stored value for the MPCC. Third, if the non-AP MLD misses acquiring Beacons from APs of the associated AP MLD (either due to sleep or collision or interference or other reasons), when acquiring the next Beacon, the non-AP MLD may examine (e.g., always examine, in some embodiments) an MPCC value from the latest received Basic ML element to determine if that MPCC value is different than the stored value for the MPCC. Fourth, if the non-AP MLD determines that the received MPCC value is different than the stored MPCC value, the non-AP MLD may determine that the critical MLD level parameters have been updated. The non-AP MLD may then re-acquire latest MLD level parameters critical updates from a current management frame (e.g., Beacon, Probe Response, or (Re)Association Response) by acquiring Multi-Link specific elements which are defined as carrying critical MLD level parameters including one or more elements listed above plus any other elements carrying MLD level parameters.

In some embodiments, the MPCC subfield may not be included in the RNR element, since the MPCC subfield is per MLD level and not per BSS/AP level. In some embodiments, the All Updates Included subfield may not be set, since the updated critical MLD level parameters are carried in every Beacon and Probe Response frames transmitted by each of the APs. So, all the updated critical MLD level parameters may be present (e.g., always present, in some embodiments) in the current management frame (e.g., Beacon, Probe Response, or (Re)Association Response) from where MPCC can be acquired.

This second embodiment may not overload BSS Parameters Change Count to also indicate MLD level parameters updates as done in the first embodiment. The second embodiment may be more efficient solution because the acquisition of critical MLD level parameters may only happen when one or more of these critical MLD level parameters are actually updated and not when BSS level parameters are updated for affiliated APs, which is a possible drawback of the first embodiment.

### 7. Third Embodiment

In the third embodiment, changes from the conventional mechanism for indicating critical MLD level parameters updates can be minimized. The AP MLD may just set the Critical Update Flag (CUF) subfield (e.g., CUF subfield 666 in FIG. 6C) to 1 until and including the next DTIM Beacon frame, whenever any of the critical MLD level parameters are updated, including but not limited to updates to MLD level parameters in one or more of the following elements: (1) Basic Multi-Link element, (2) Reconfiguration Multi-Link element, (3) TID-to-Link Mapping element, and/or (4) Multi-Link Traffic Indication element. Updates to MLD level parameters in other elements not listed above may also be classified as critical MLD level parameters update and result in setting of CUF subfield to 1.

Whenever the non-AP MLD sees/determines/detects/identifies that the CUF is changed from 0 to 1, the non-AP MLD may re-acquire latest MLD level parameters from the Multi-Link specific elements which carry critical MLD level parameters including one or more elements indicated above plus any other elements defined to be carrying critical MLD level parameters, to get/obtain/acquire the latest MLD level parameters from the management frame (e.g., Beacon, Probe Response, or (Re)Association Response) for that AP MLD.

If the non-AP MLD misses any Beacons, the non-AP MLD may also re-acquire latest MLD level parameters by receiving latest Multi-Link specific elements which carry critical MLD level parameters for the associated AP MLD. This approach may not be optimal as the non-AP MLD is to acquire latest MLD level parameters anytime the CUF is set. The CUF could get set when BSS level parameters are updated for one or more affiliated APs of the AP MLD, and this may result in non-AP MLDs acquiring critical MLD level parameters again when none of the MLD level parameters were actually updated. Also, if the non-AP MLD misses Beacons, the non-AP MLD may acquire critical MLD level parameters even when none of those parameters are updated, which is also not optimal.

In some embodiments, an AP affiliated with an AP MLD may set the Critical Update Flag subfield to 1 if any of the following conditions are met: (1) there is a change to a value carried in the BSS Parameters Change Count subfield of the MLD Parameters field in the Reduced Neighbor Report element for any reported AP affiliated with the same AP MLD as the AP; (2) there is a change to a value carried in the BSS Parameters Change Count subfield in the Common Info field of the Basic Multi-Link element corresponding to the AP; (3) A new affiliated AP is added to the AP MLD with which the AP is affiliated; (4) a Reconfiguration Multi-Link element is included or modified by adding a new Per-STA Profile subelement by the AP affiliated with an AP MLD; and/or (5) a TID-To-Link Mapping (TTLM) is advertised by the AP MLD (e.g., in Beacon and Probe Response frames).

### 8. Fourth Example Embodiment

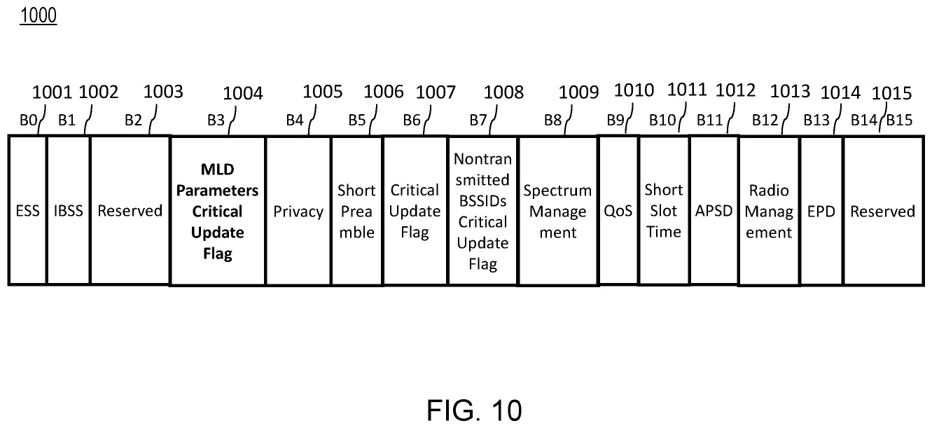

FIG. 10 illustrates another example field format for signaling updates on MLD parameters, according to an example implementation of the present disclosure. FIG. 10 shows a Capability Information field format 1000 (for non-DMG STA) according to an example implementation of the present disclosure. The Capability Information field format 1000 may include the subfields of ESS 1001, IBSS 1002, Reserved 1003, MLD Parameters Critical Update Flag (also referred to as “MP-CUF”) 1004, Privacy 1005, Short Preamble 1006, Critical Update Flag 1007, Non-transmitted BSSIDs Critical Update Flag 1008, Spectrum Management 1009, QoS 1010, Short Slot Time 1011, APSD 1012, Radio Management 1013, EPD 1014, and/or Reserved 1015.

In the fourth embodiment, instead of using the existing CUF subfield, a new MLD Parameters Critical Update Flag (MP-CUF) subfield (e.g., MP-CUF subfield 1004) may be defined. The MP-CUF subfield may be set to 1 to indicate critical updates to MLD level parameters until and including the next DTIM Beacon frame. In this manner, the currently defined CUF subfield may not be overloaded to indicate critical updates to both BSS level parameters and also the MLD level parameters.

The fourth embodiment may be more efficient than the third embodiment, because the non-AP MLD may not end up acquiring critical MLD level parameters when only BSS level parameters are updated for affiliated APs, as can happen in the third embodiment.

The MP-CUF subfield may be added to the existing Capability Information field (e.g., Capability Information field format 1000 as shown in FIG. 10) by using Reserved bit B3 for the MP-CUF subfield. This field may be carried in Beacon, probe Response, (Re)Association Response frames. In some embodiments, the AP MLD may set the MP-CUF subfield to 1 until and including the next DTIM Beacon frame, whenever any of the critical MLD level parameters are updated, including but not limited to updates to MLD level parameters in one or more of the following elements: (1) Basic Multi-Link element, (2) Reconfiguration Multi-Link element, (3) TID-to-Link Mapping element, and/or (4) Multi-Link Traffic Indication element. Updates to MLD level parameters in other elements not listed above may also be classified as critical MLD level parameters update and result in setting of MP-CUF subfield to 1.

Whenever the non-AP MLD sees/identifies/determines/detects that the MP-CUF subfield is changed from 0 to 1, the non-AP MLD may re-acquire latest MLD level parameters from the Multi-Link specific elements which carry critical MLD level parameters including one or more elements indicated above plus any other elements defined to be carrying critical MLD level parameters, to get/obtain/acquire the latest MLD level parameters from Beacon, Probe Response, (Re)Association Response frames for that AP MLD.

If the non-AP MLD misses any Beacons, the non-AP MLD might have missed setting of the MP-CUF subfield. Hence, in this case the non-AP MLD may also re-acquire latest MLD level parameters by receiving latest Multi-Link specific elements which carry critical MLD level parameters for the associated AP MLD from Beacon, Probe Response, or (Re)Association Response frames.

### 9. Fifth Embodiment

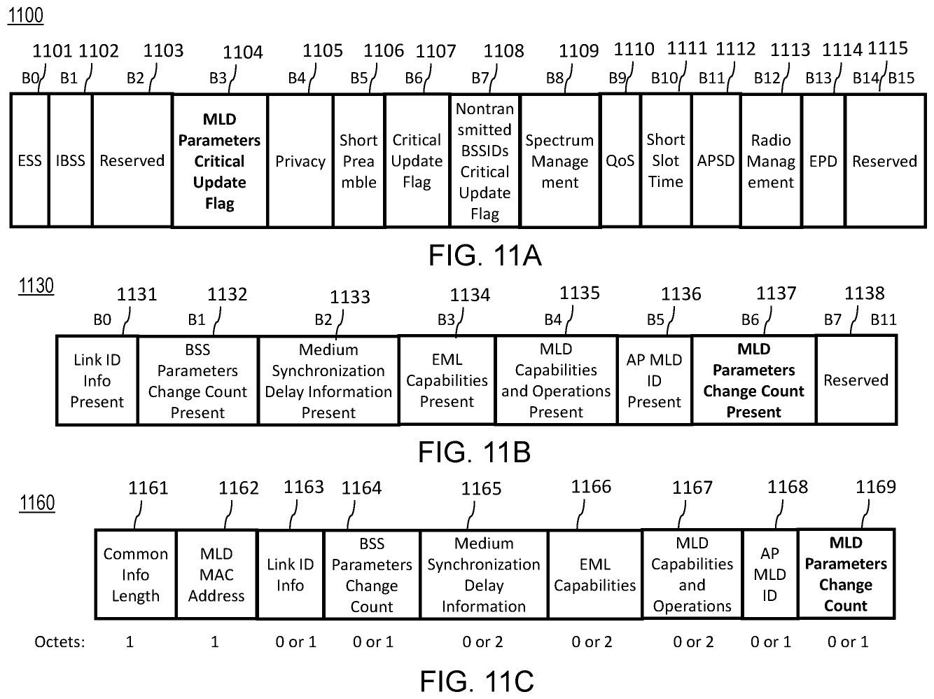

FIG. 11A to FIG. 11C illustrate yet another example(s) of field formats for signaling updates on MLD parameters, according to example implementation(s) of the present disclosure. FIG. 11A shows a Capability Information field format 1100 according to an example implementation of the present disclosure. The Capability Information field format 1100 may include the subfields of ESS 1101, IBSS 1102, Reserved 1103, MLD Parameters Critical Update Flag (also referred to as “MP-CUF”) 1104, Privacy 1105, Short Preamble 1106, Critical Update Flag 1107, Non-transmitted BSSIDs Critical Update Flag 1108, Spectrum Management 1109, QoS 1110, Short Slot Time 1111, APSD 1112, Radio Management 1113, EPD 1114, and/or Reserved 1115. FIG. 11B shows a Presence Bitmap subfield 1130 of the Basic Multi-Link element format according to an example implementation of the present disclosure. The Presence Bitmap subfield 1130 may include the subfields of Link ID Info Present 1131, BSS Parameters Change Count (BPCC) Present 1132, Medium Synchronization Delay Information Present 1133, EML Capabilities Present 1134, MLD Capabilities and Operations Present 1135, AP MLD ID present 1135, MLD Parameters Change Count Present (also referred to as “MPCC Present”) 1137, and/or Reserved 1138. FIG. 11C shows a Common Info field format 1160 of the Basic Multi-Link element format according to an example implementation of the present disclosure. The Common Info field format 1160 may include the subfields of Common Info Length 1161, MLD MAC Address 1162, Link ID Info 1163, BSS Parameters Change Count (BPCC) 1164, Medium Synchronization Delay Information 1165, EML Capabilities 1166, MLD Capabilities and Operations 1167, AP MLD ID 1168, and/or MLD Parameters Change Count (also referred to as “MPCC”) 1169.

In the fifth embodiment, the MLD Parameters Critical Update Flag (MP-CUF) subfield (e.g., MP-CUF subfield 1104) can be used in combination with the MLD Parameters Change Count (MPCC) subfield (e.g., MPCC subfield 1169) which is also added as MPCC subfield 959 in the second embodiment to indicate to non-AP MLDs when critical MLD level parameters are updated. In other words, the fifth embodiment may add both the new MP-CUF subfield (e.g., MP-CUF subfield 1104) and the new MPCC subfield (e.g., MPCC subfield 1169) as shown in FIG. 11A and FIG. 11C.

The MP-CUF subfield (e.g., MP-CUF subfield 1104) may be added to the existing Capability Information field (e.g., Capability Information field format 1100) by using Reserved bit B3 for the MP-CUF subfield. This modified Capability Information field may be carried in Beacon, probe Response, and/or (Re)Association Response frames. The “MLD Parameters Change Count Present” (also referred to as “MPCC Present” subfield; e.g., MPCC Present subfield 1137) may be added in the Presence Bitmap subfield (e.g., Presence Bitmap subfield 1130) of the Basic ML element to indicate the presence of the MLD Parameters Change Count subfield. The MPCC Present subfield may be set to 1 if the MPCC subfield (e.g., MPCC subfield 1169) is included in the Common Info field (e.g., Common Info field 1160) for the Basic ML element. Otherwise, the MPCC Present subfield may be set to 0. The MPCC subfield may be added in the Common Info field of the Basic ML element.

In the fifth embodiments, similar to the second embodiment, the new MPCC subfield may be carried in the Common Info field of the Basic Multi-Link element in the Beacon, Probe Response and/or (Re)Association Response frame. The AP MLD may increment the MPCC subfield (using module 256 operation, excluding value 255) whenever any of the critical MLD level parameters are updated. Updates to MLD level parameters in one or more of following elements can be classified as critical updates for MLD level parameters: (1) Basic Multi-Link element (excluding update to MPCC itself), (2) Reconfiguration Multi-Link element, (3) TID-to-Link Mapping element, and/or (4) Multi-Link Traffic Indication element. Updates to MLD level parameters in other elements not listed above may also be considered as critical updates for MLD level parameters by the AP MLD and may result in incrementing of MPCC value. A single MPCC value may be maintained by the AP MLD.

### 9-1. AP MLD Behavior

The AP MLD may perform the following behaviors/procedures/processes to indicate MLD level parameters critical updates to non-AP MLDs with MP-CUF and MPCC. First, whenever any critical updates on MLD level parameters happen for the AP MLD, a system/method may increment the MPCC for the AP MLD. The updated MPCC value may be carried in the Common Info field of the Basic ML element by the reporting AP. Each affiliated AP of the AP MLD may include MPCC subfield in the Basic ML element in the Beacon, Probe Response, and/or (Re)Association Response frames each AP transmits. Second, the AP MLD may also set the MLD Parameters Critical Update Flag (MP-CUF) subfield to 1 until and including the next DTIM Beacon frame, to trigger non-AP MLD to examine latest MPCC value.

### 9-2. Non-AP MLD Behavior

The non-AP MLD may have following behaviors/procedures/processes to detect and/or acquire latest MLD level parameters critical updates. First, the non-AP MLD may maintain/store a record of the most recently received MPCC subfield value for the AP MLD it is associated with. Second, when the non-AP MLD identifies/determines/detects that the MP-CUF is set, the non-AP MLD may examine an MPCC value from the latest received Basic ML element to determine if that MPCC value is different than the stored value for the MPCC. Third, if the non-AP MLD misses acquiring Beacons from APs of the associated AP MLD (either due to sleep or collision or interference), when acquiring the next Beacon, the non-AP MLD may examine (e.g., always examine, in some embodiments) an MPCC value from the latest received Basic ML element to determine if that MPCC value is different than the stored value for the MPCC. Fourth, if the non-AP MLD determines that the received MPCC value is different than the stored MPCC value, the non-AP MLD may determine that the critical MLD level parameters have been updated. The non-AP MLD may then re-acquire latest MLD level parameters critical updates from the current management frame by acquiring Multi-Link specific elements which are defined as carrying critical MLD level parameters including one or more elements listed above plus any other elements carrying MLD level parameters.

The fifth embodiment may be more efficient than the second embodiment because it assigns a separate MLD Parameters CUF (MP-CUF) for indicating critical updates for MLD level parameters. Hence, the non-AP MLDs do not need to examine MPCC value every time there is a BSS level parameters critical update which sets the CUF subfield, as can happen in the second embodiment.

### 10. Other Example Embodiments (which May Include Some Foregoing Embodiments)

In some embodiments (e.g., the third embodiment), a device (e.g., STA-1) within a non-access point multi-link device (e.g., non-AP MLD 420) having a plurality of wireless links (e.g., links 430-1, . . . , 430-k), may include one or more processors (e.g., processors 316). The one or more processors may be configured to receive, through a receiver via a link of the plurality of wireless links corresponding to the device in a wireless local area network (WLAN), a first frame (e.g., beacon, probe response, or (Re)-associate frame) from an AP MLD (e.g., AP MLD 410). The first frame may include a first subfield (e.g., CUF subfield 666), the first subfield indicating whether there is an update on one or more basic service set (BSS) level parameters or one or more MLD level parameters different from the one or more BSS level parameters. The one or more processors may be configured to determine whether the first subfield is set to a first value indicating that there is an update on the one or more BSS level parameters or the one or more MLD level parameters. Responsive to determining that the first subfield is set to the first value, the one or more processors may be configured to determine one or more updated MLD level parameters.

In some embodiments, the one or more processors may be configured to perform reconfiguration of the device using the one or more updated MLD level parameters. For example, if the Maximum Number of Simultaneous Links (e.g., Maximum Number of Simultaneous Links subfield 761) is increased, it may indicate that a new AP has been added at the AP MLD. Knowing/detecting/being aware of this information, the non-AP MLD can perform ML association which includes the new link as well and can achieve better overall performance. If TID-To-Link Mapping Negotiation Support (e.g., TID-To-Link Mapping Negotiation Support subfield 763) is updated from value 1 to value 3, the non-AP MLD can take advantage of this change and establish more flexible TID-to-Link mapping over associated links which can prioritize low-latency traffic on certain higher quality link (e.g., 6 GHZ). If EML Capabilities (e.g., EML Capabilities subfield 680) are updated by the AP MLD (for example, EMLSR Support (subfield 731) or EMLMR Support (subfield 734) are enabled), then the non-AP MLD can take this information into account and perform EMLSR or EMLMR operations with the AP MLD. The Reconfiguration Multi-Link element may be sent in Beacon and Probe Response frames and provide information about one or more affiliated APs being removed from the AP MLD. The Reconfiguration Multi-Link element may indicate to the non-AP MLDs when a specific affiliated AP is to be removed by providing a Delete Timer value (e.g., Delete Timer subfield 853) for the AP removal in the STA Info field (e.g., STA Info field 850). It is beneficial for the non-AP MLD to receive this information, so that the non-AP MLD can learn which AP/APs are being removed and can adjust its ML operation accordingly to avoid any disruption to its operation. The TID-to-Link Mapping element advertised in the Beacon may provide information on which APs/links are being disabled or later enabled by the AP MLD. It is also beneficial for a non-AP MLD to receive this information immediately, so that the non-AP MLD can learn/determine which APs are being disabled and can adjust/control its ML operation accordingly to avoid any disruption to its operation.

In some embodiments, the first frame may include a second subfield (e.g., BPCC subfield 573 or BPCC subfield 604) indicating a number of changes of the one or more BSS parameters. Responsive to determining that the first subfield is set to the first value, the one or more processors may be configured to determine, based at least on a value of the second subfield, one or more updated BSS level parameters. The one or more processors may be configured to perform reconfiguration of the device (e.g., update operating parameters of the device) using the one or more updated BSS level parameters. In some embodiments, the first frame may be one of a beacon or a probe response frame.

In some embodiments, the one or more MLD level parameters may be carried in at least one of a basic multi-link element, a reconfiguration multi-link element, a traffic identifier (TID)-to-link mapping element, or a multi-link traffic indication element. In some embodiments, the update on the one or more MLD level parameters may relate to at least one of (1) adding a new device to the AP MLD, (2) removing a device from the AP MLD, (3) updating a value of a medium synchronization delay information subfield, (4) updating a value of an enhanced multi-link (EML) capabilities subfield, or (5) updating a value of an MLD capabilities and operations subfield.

In some embodiments, responsive to determining that the device has not received a beacon frame from the AP MLD, the one or more processors may be configured to wirelessly transmit, through a transmitter via the link to the AP MLD, a second frame (e.g., Probe Request frame) requesting the one or more MLD level parameters. The first frame (e.g., Probe Response frame) may be received responsive to transmitting the second frame.

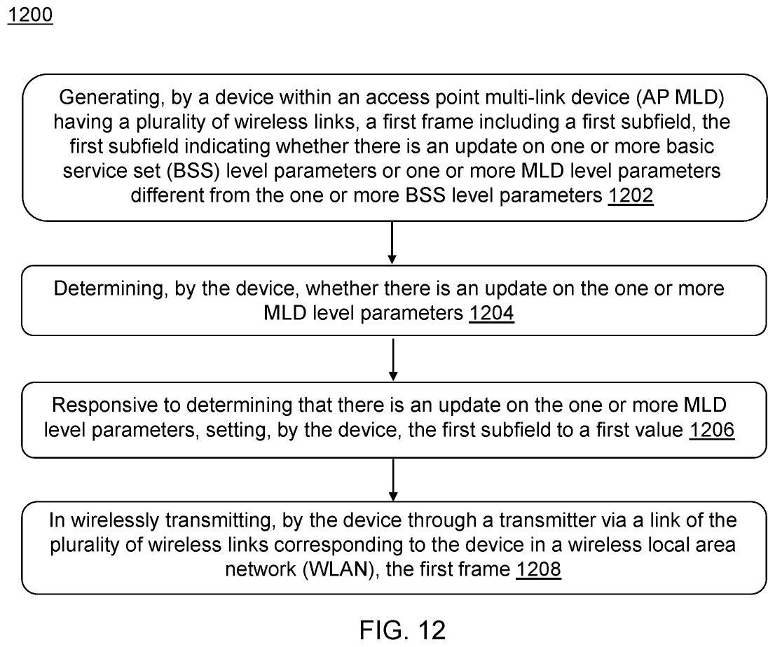

FIG. 12 is a flowchart showing a process 1200 of signaling updates on MLD parameters, according to an example implementation of the present disclosure. In some embodiments, the process 1200 is performed by a device within an access point multi-link device (e.g., AP-1 of AP MLD 410) having a plurality of wireless links (e.g., link 430-1, . . . , link 430-k). In some embodiments, the process 1200 is performed by other entities. In some embodiments, the process 1200 includes more, fewer, or different steps than shown in FIG. 12.

In one approach, the device (e.g., AP-1 411-1) may generate 1202 a first frame (e.g., Beacon, Probe Response, or (Re)-Association Response frame) including a first subfield (e.g., CUF subfield 666). The first subfield may indicate whether there is an update on one or more basic service set (BSS) level parameters or one or more MLD level parameters different from the one or more BSS level parameters. In some embodiments, the first frame may be one of a beacon or a probe response frame.

In some embodiments, the one or more MLD level parameters may be carried in at least one of a basic multi-link element, a reconfiguration multi-link element, a traffic identifier (TID)-to-link mapping element, or a multi-link traffic indication element. In some embodiments, the update on the one or more MLD level parameters may relate to at least one of (1) adding a new device to the AP MLD, (2) removing a device from the AP MLD, (3) updating a value of a medium synchronization delay information subfield, (4) updating a value of an enhanced multi-link (EML) capabilities subfield, or (5) updating a value of an MLD capabilities and operations subfield.

In one approach, the device may determine 1204 whether there is an update on the one or more MLD level parameters. In one approach, responsive to determining that there is an update on the one or more MLD level parameters, the device may set 1206 the first subfield (e.g., CUF subfield 666) to a first value (e.g., value 1). In some embodiments, in setting the first subfield to the first value, the device may set the first subfield to the first value until and including an end of a predetermined time interval. The predetermined time interval may be a delivery traffic indication message (DTIM) interval on the link.

In some embodiments, the first frame may include a second subfield (e.g., BPCC subfield 573 or BPCC subfield 604) indicating a number of changes of the one or more BSS parameters. The device may determine whether there is a change to a value carried in the second subfield. Responsive to determining that there is a change to a value carried in the second subfield, the device may set the first subfield (e.g., CUF subfield 666) to the first value (e.g., value 1).

In one approach, the device may wirelessly transmit 1208, through a transmitter via a link of the plurality of wireless links corresponding to the device in a wireless local area network (WLAN), the first frame.

### 11. Advantages

Embodiments in the present disclosure have at least the following advantages and benefits. First, embodiments in the present disclosure can provide useful techniques for notifying a non-AP MLD of critical updates on MLD level parameters. In some embodiments, a Critical Update Flag (CUF) subfield can be set not only for updates on BSS level parameters but also for updates on MLD parameters in the Basic ML element, hence those updates (e.g., MLD Parameters subfield 570 in the Basic ML element) can be indicated to the non-AP MLD using the CUF subfield. The critical MLD level parameters may include MLD level parameters in one or more of the following elements or other elements in Beacon or Probe Response carrying MLD level parameters: (1) Basic Multi-Link element, (2) Reconfiguration Multi-Link element, (3) TID-to-Link Mapping element, and/or (4) Multi-Link Traffic Indication element.

Second, embodiments in the present disclosure can provide useful techniques for indicating to non-AP MLDs which are associated with an AP MLD that critical MLD level parameters have been updated, so that an associated non-AP MLD can consider updated AP MLD capabilities in its ML operation with the AP MLD. For example, if the Maximum Number of Simultaneous Links is increased, it may indicate that a new AP has been added at the AP MLD. Knowing/detecting/being aware of this information, the non-AP MLD can perform ML association which includes the new link as well and can achieve better overall performance. If TID-To-Link Mapping Negotiation Support is updated from value 1 to value 3, the non-AP MLD can take advantage of this change and establish more flexible TID-to-Link mapping over associated links which can prioritize low-latency traffic on certain higher quality link. If EML Capabilities are updated by the AP MLD (for example, EMLSR Support or EMLMR Support are enabled), then the non-AP MLD can take this information into account and perform EMLSR or EMLMR operations with the AP MLD. The Reconfiguration Multi-Link element may indicate to the non-AP MLDs when a specific affiliated AP is to be removed by providing a Delete Timer value for the AP removal in the STA Info field. It is beneficial for the non-AP MLD to receive this information, so that the non-AP MLD can learn which AP/APs are being removed and can adjust its ML operation accordingly to avoid any disruption to its operation. The TID-to-Link Mapping element advertised in the Beacon may provide information on which APs/links are being disabled or later enabled by the AP MLD. It is also beneficial for a non-AP MLD to receive this information immediately, so that the non-AP MLD can learn which APs are being disabled and can adjust its ML operation accordingly to avoid any disruption to its operation.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A device within an access point multi-link device (AP MLD) having a plurality of wireless links, the device comprising:
one or more processors configured to:
generate a first frame including a first subfield, the first subfield indicating whether there is an update on one or more basic service set (BSS) level parameters or one or more MLD level parameters different from the one or more BSS level parameters;
determine whether there is an update on the one or more MLD level parameters;
responsive to determining that there is an update on the one or more MLD level parameters, set the first subfield to a first value; and
wirelessly transmit, through a transmitter via a link of the plurality of wireless links corresponding to the device in a wireless local area network (WLAN), the first frame.

2. The device according to claim 1, wherein
the first frame includes a second subfield indicating a number of changes of the one or more BSS parameters,
the one or more processors are configured to:
determine whether there is a change to a value carried in the second subfield; and
responsive to determining that there is a change to a value carried in the second subfield, set the first subfield to the first value.

3. The device according to claim 1, wherein the first frame is one of a beacon or a probe response frame.

4. The device according to claim 1, wherein the one or more MLD level parameters are carried in at least one of a basic multi-link element, a reconfiguration multi-link element, a traffic identifier (TID)-to-link mapping element, or a multi-link traffic indication element.

5. The device according to claim 1, wherein the update on the one or more MLD level parameters relates to at least one of (1) adding a new device to the AP MLD, (2) removing a device from the AP MLD, (3) updating a value of a medium synchronization delay information subfield, (4) updating a value of an enhanced multi-link (EML) capabilities subfield, or (5) updating a value of an MLD capabilities and operations subfield.

6. The device according to claim 1, wherein in setting the first subfield to the first value, the one or more processors are configured to:
set the first subfield to the first value until and including an end of a predetermined time interval.

7. The device according to claim 6, wherein the predetermined time interval is a delivery traffic indication message (DTIM) interval on the link.

8. A device within a non-access point multi-link device (non-AP MLD) having a plurality of wireless links, the device comprising:
one or more processors configured to:
receive, through a receiver via a link of the plurality of wireless links corresponding to the device in a wireless local area network (WLAN), a first frame from an AP MLD, the first frame including a first subfield, the first subfield indicating whether there is an update on one or more basic service set (BSS) level parameters or one or more MLD level parameters different from the one or more BSS level parameters;
determine whether the first subfield is set to a first value indicating that there is an update on the one or more BSS level parameters or the one or more MLD level parameters;
responsive to determining that the first subfield is set to the first value, determine one or more updated MLD level parameters; and
perform reconfiguration of the device using the one or more updated MLD level parameters.

9. The device according to claim 8, wherein
the first frame includes a second subfield indicating a number of changes of the one or more BSS parameters,
the one or more processors are configured to:
responsive to determining that the first subfield is set to the first value, determine, based at least on a value of the second subfield, one or more updated BSS level parameters; and
perform reconfiguration of the device using the one or more updated BSS level parameters.

10. The device according to claim 8, wherein the first frame is one of a beacon or a probe response frame.

11. The device according to claim 8, wherein the one or more MLD level parameters are carried in at least one of a basic multi-link element, a reconfiguration multi-link element, a traffic identifier (TID)-to-link mapping element, or a multi-link traffic indication element.

12. The device according to claim 8, wherein the update on the one or more MLD level parameters relates to at least one of (1) adding a new device to the AP MLD, (2) removing a device from the AP MLD, (3) updating a value of a medium synchronization delay information subfield, (4) updating a value of an enhanced multi-link (EML) capabilities subfield, or (5) updating a value of an MLD capabilities and operations subfield.

13. The device according to claim 8, wherein
the one or more processors are configured to:
responsive to determining that the device has not received a beacon frame from the AP MLD, wirelessly transmit, through a transmitter via the link to the AP MLD, a second frame requesting the one or more MLD level parameters, and
the first frame is received responsive to transmitting the second frame.

14. A method comprising:
generating, by a device within an access point multi-link device (AP MLD) having a plurality of wireless links, a first frame including a first subfield, the first subfield indicating whether there is an update on one or more basic service set (BSS) level parameters or one or more MLD level parameters different from the one or more BSS level parameters;
determining, by the device, whether there is an update on the one or more MLD level parameters;
responsive to determining that there is an update on the one or more MLD level parameters, setting, by the device, the first subfield to a first value; and
wirelessly transmitting, by the device through a transmitter via a link of the plurality of wireless links corresponding to the device in a wireless local area network (WLAN), the first frame.

15. The method according to claim 14, wherein
the first frame includes a second subfield indicating a number of changes of the one or more BSS parameters,
the method further comprises:
determining whether there is a change to a value carried in the second subfield; and
responsive to determining that there is a change to a value carried in the second subfield, setting the first subfield to the first value.

16. The method according to claim 14, wherein the first frame is one of a beacon or a probe response frame.

17. The method according to claim 14, wherein the one or more MLD level parameters are carried in at least one of a basic multi-link element, a reconfiguration multi-link element, a traffic identifier (TID)-to-link mapping element, or a multi-link traffic indication element.

18. The method according to claim 14, wherein the update on the one or more MLD level parameters relates to at least one of (1) adding a new device to the AP MLD, (2) removing a device from the AP MLD, (3) updating a value of a medium synchronization delay information subfield, (4) updating a value of an enhanced multi-link (EML) capabilities subfield, or (5) updating a value of an MLD capabilities and operations subfield.

19. The method according to claim 14, wherein setting the first subfield to the first value comprises:
setting the first subfield to the first value until and including an end of a predetermined time interval.

20. The method according to claim 19, wherein the predetermined time interval is a delivery traffic indication message (DTIM) interval on the link.
